(19) United States
(12) Patent Application Publication
(10) Pub. No.: US 2025/0128222 A1
(43) Pub. Date: Apr. 24, 2025

(54) PLATE GRID DISTRIBUTORS AND METHODS OF USING THE SAME

(71) Applicant: Dow Global Technologies LLC, Midland, MI (US)

(72) Inventors: Matthew T. Pretz, Freeport, TX (US); Donald F. Shaw, Forked River, NJ (US); Richard E. Walter, Long Valley, NJ (US); Albert Meza, Houston, TX (US); Fermin Sandoval, Houston, TX (US); Liwei Li, Freeport, TX (US)

(73) Assignee: Dow Global Technologies LLC, Midland, MI (US)

(21) Appl. No.: 18/572,568

(22) PCT Filed: Jun. 24, 2022
(86) PCT No.: PCT/US2022/034847

§ 371 Date: Dec. 20, 2023

Related U.S. Application Data
(60) Provisional application No. 63/216,778, filed on Jun. 30, 2021.

(51) Int. Cl. B01J 3/02

(52) U.S. Cl. CPC B01J 3/02; B01J 2208/00911; B01J 2208/0092

(57) ABSTRACT

According to one or more embodiments, a plate grid distributor for distributing a fluid in a vessel or a plenum for removing a fluid from a vessel may include a plate and a skirt. The skirt may be in direct contact with the plate and may include a first portion and a second portion. The first portion may be in direct contact with the plate and the second portion may be in direct contact with the first portion. The first portion may have a first allowable stress and the second portion may have a second allowable stress. According to one or more other embodiments, a method of distributing a fluid through a plate grid distributor in a vessel may include passing the fluid into the vessel and directing the fluid through the plate grid distributor.

### CROSS-REFERENCE TO RELATED APPLICATIONS

The present application is a PCT application claiming priority to U.S. Provisional Patent Application No. 63/216,778, filed Jun. 30, 2021, and entitled “PLATE GRID DISTRIBUTORS AND METHODS OF USING THE SAME,” the contents of which are incorporated in their entirety herein.

### BACKGROUND

### Field

The present specification generally relates chemical processing and, more specifically, to systems and methods for distributing a fluid through a distributor.

### Technical Background

Gaseous chemicals may be fed into reactors or other vessels through distributors. Distributors may be utilized to promote balanced distribution of a feed chemical stream into such reactors or vessels. Such distribution of feed chemicals may promote desired reactions and may maintain mass transport equilibriums in chemical systems. However, mechanical loads on distributors may be challenging, particularly as distributors are made larger and are in hot environments.

### SUMMARY

In a number of chemical processes, chemical feed streams are fed through plate grid distributors into a hot environment, such as a reactor or other vessels. In other chemical processes, fluids are removed through a plenum from hot environments, such as reactors or other vessels. With increasing reactor or vessel sizes, such as where plate grid distributors or plenums are at least 20 ft, additional mechanical support may be needed to help support the plate grid distributors. Further, these hot environments may elevate the temperature of the plate grid distributors, such as a plate of the plate grid distributor. As temperatures of the plate grid distributors may elevate, the plate may thermally expand outwards towards outer walls of the reactors or other vessels. This is particularly problematic in some fluidized bed vessels, where the hot environment may cause the plate of the plate grid distributor to thermally expand and contract. In turn, thermal expansion and contraction of the plate may raise difficulties in supporting the plate of the plate grid distributor. Accordingly, there is an on-going need for improved plate grid distributors.

It has been found that plate grid distributors with a skirt having multiple different portions may provide adequate support for plates of plate grid distributors while meeting the needs of supporting the plate during the thermal expansion and contraction of the plate. Embodiments of such plate grid distributors are described herein. Embodiments of the present disclosure meet this need by utilizing skirts having a portions with a relatively high allowable cost at high temperatures seen during reaction, which permits bending of the skirt without failure when the plate grid expands. The design incorporates such materials with high allowable stress at particular portions of the skirt that observe mechanical stresses, but uses other materials in areas not susceptible to the maximum stresses, which may reduce material costs. Such concepts may also apply to other internals in a reactor, such as plenums, as is discussed herein.

According to one embodiment, a plate grid distributor for distributing a fluid in a vessel may include a plate and a skirt. The plate may include a top surface, a bottom surface opposite the top surface, and a plurality of apertures passing from the top surface to the bottom surface. The skirt may be in direct contact with the bottom surface of the plate at or near an outer periphery of the plate. The skirt may extend substantially vertically from the plate and towards a floor of the vessel. The skirt may include a first portion and a second portion. The first position may be in direct contact with the plate and may have a first allowable stress. The second portion may be positioned below the first portion and may be in direct contact with the first portion and extending downward towards the floor of the vessel. The material of the second portion may have a second allowable stress. The first allowable stress may be 200 psi less than the second allowable stress at 1,400° F. The second allowable stress may be greater than 3,000 psi at 1,400° F.

According to another embodiment, a plenum for removing a fluid from a vessel may include a plate and a skirt. The plate may include a top surface and a bottom surface opposite the top surface. The skirt may be in direct contact with the top surface of the plate at or near an outer periphery of the plate. The skirt may extend substantially vertically from the plate and towards a top of the vessel. The skirt may include a first portion and a second portion. The first portion may be in direct contact with the plate. The material of the first portion may have a first allowable stress. The second portion may be positioned above the first portion and may be in direct contact with the first portion. The second portion may extend upward towards the top of the vessel. The material of the second portion may have a second allowable stress. The first allowable stress may be 200 psi less than the second allowable stress at 1,400° F. The second allowable stress may be greater than 3,000 psi at 1,400° F.

According to another embodiment, a method of distributing a fluid in a vessel may include passing a fluid into the vessel at reaction conditions through a gaseous feed conduit below the plate grid distributor and directing the fluid through a plate grid distributor in the vessel. The plate grid distributor may include a plate and a skirt. The plate may include a top surface, a bottom surface opposite the top surface, and a plurality of apertures passing from the top surface to the bottom surface. A skirt may be in direct contact with the bottom surface of the plate at or near an outer periphery of the plate. The skirt may extend substantially vertically from the plate and towards a floor of the vessel. The skirt may include a first portion and a second portion. The first portion may be in direct contact with the plate. The material of the first portion may have a first allowable stress. The second portion may be positioned below the first portion and in direct contact with the first portion. The second portion may extend downward towards the floor of the vessel. The material of the second portion may have a second allowable stress. The first allowable stress may be 200 psi less than the second allowable stress at 1,400° F. The second allowable stress may be greater than 3,000 psi at 1,400° F. A temperature differential between the top surface of the plate and the floor of the vessel may be greater than or equal to 500° F.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 is a schematic illustration of a cross-sectional view of a vessel and plate grid distributor, in accordance with one or more embodiments of the present disclosure;

FIG. 2 is a schematic illustration of a plate grid distributor and skirt, in accordance with one or more embodiments of the present disclosure; and

FIG. 3 is a schematic illustration of a cross-sectional view of a vessel and plenum, in accordance with one or more embodiments of the present disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed, according to one or more embodiments described herein, towards plate grid distributors, plenums, and methods for using such. Generally, the plate grid distributors and plenums described herein may comprise a plate and a skirt. The plate grid distributors described herein may be used for distributing a fluid in a vessel. The plenums described herein may be used for removing a fluid from a vessel. The vessel may include a gaseous feed conduit that may be distributed in the vessel by the plate grid distributor. The vessel may include a plenum outlet in the vessel that may remove fluid from the vessel. Generally, the plate distributors and plenums described herein comprise a skirt that may help support the plate. In some embodiments, such a skirt may be needed to provide support around the perimeter of the plate. As chemical processes proceed in the vessel, the plate may thermally expand due to the reaction conditions. The skirt may include a first portion and a second portion. As further described herein, the first portion and the second portion may bend as the plate thermally expands to continue to support the plate as chemical processes proceed in the vessel at elevated temperatures.

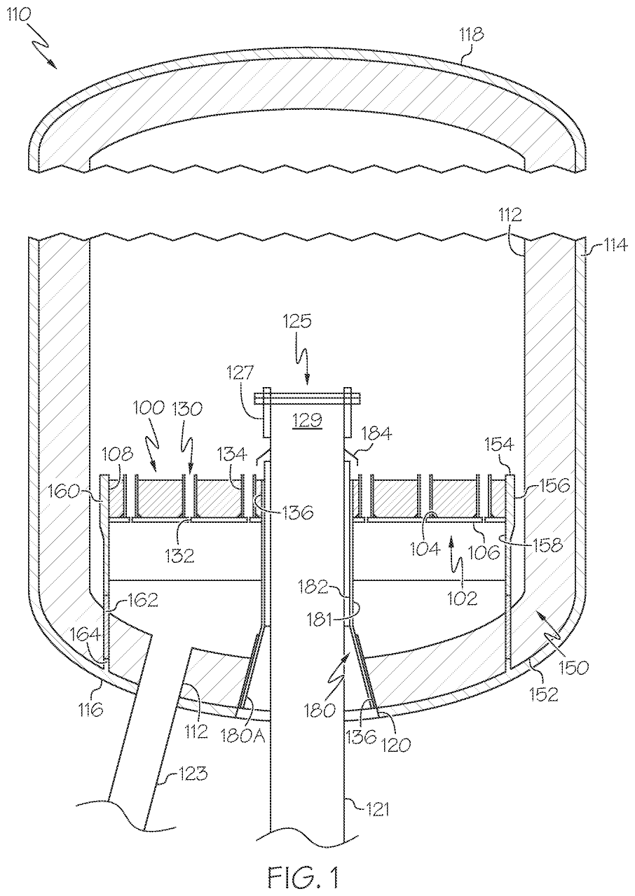

Referring now to FIG. 1, the plate grid distributors 100 of the present disclosure may be positioned in a vessel 110. The vessel 110 may have various configurations. The vessel 110 may include one or more polyhedron, sphere, cylinder, cone, irregular shape, combinations thereof, and/or portions thereof. For example, the vessel 110 may include a right hollow cylinder with a longitudinal axis. The vessel 110 may include a refractory-lined inner wall 112, an outer wall 114, a floor 116, a top 118, a catalyst feed conduit receiving passageway 120, and a gaseous feed conduit receiving passageway 122.

According to one or more embodiments, the plate grid distributor 100 for distributing a fluid in a vessel 110 may comprise a plate 102. The plate 102 may comprise a top surface 104 and a bottom surface 106. The bottom surface 106 may be opposite the top surface 104 and may be spaced apart from the top surface 104. The plate 102 may comprise an outer surface 108. The outer surface 108 may have a portion that is normal to the top surface 104 and the bottom surface 106. The outer surface 108 can be welded to the top surface 104 and/or bottom surface 106. The plate 102 may have an average diameter from greater than or equal to 5 feet (1.5 meters (m)) to less than or equal to 75 feet (22.9 m), such as from greater than or equal to 10 feet (3.0 m) to less than or equal to 50 feet (15.2 m). The plate 102 may be substantially planar (i.e., the top surface 104 and the bottom surface 106 may be substantially parallel). However, it is contemplated that in additional embodiments, the plate 102 may be non-planar.

The bottom surface 106, the top surface 104, or both of the plate 102 may be refractory-lined. Additionally or alternatively, other materials with insulating properties (e.g., insulating material) may be disposed between the bottom surface 106 and the top surface 104 of the plate 102. The refractory lining, the insulating material, or both may help prevent the bottom surface 106 of the plate 102 from heating.

The plate 102 may comprise a plurality of apertures 130. Each of the plurality of apertures 130 may be in fluid communication with the bottom surface 106 of the plate 102 and the top surface 104 of the plate 102 via first aperture portions 132 and second aperture portions 134. The plurality of apertures 130 may be even with (i.e., not extend further than) the top surface 104 and/or the bottom surface 106. Alternatively, the plurality of apertures 130 may extend past (i.e., below) the bottom surface 106 and/or past (i.e., above) the top surface 104. The plurality of apertures 130 may comprise a lip that extend past the bottom surface 106, the top surface 104, or both. The second aperture portions 134 may have a greater cross-sectional area than the first aperture portions 132.

The first aperture portions 132 and the second aperture portions 134 of the plate 102 may have uniform or varying cross-sectional areas to help provide for an even distribution of gas passing through each of the plurality of apertures 130. For instance, first aperture portions 132 that are nearer to gaseous feed conduit 123 may have a greater pressure difference between the bottom surface 106 and the top surface 104 of the plate 102. As such, first aperture portions 132 of the plate 102 that are nearer to the gaseous feed conduit 123 can have a smaller cross-sectional area than first aperture portions 132 that are further from the gaseous feed conduit 123 to help equilibrate a pressure differential across the plate 102.

Still referring to FIG. 1, the plate 102 may include a bottom surface 106 and outer surface 108. The bottom surface 106 can include a plurality of apertures 130, formed by first aperture portions 132 of the plate 102. The plurality of apertures 130 may be arranged around a catalyst feed conduit passageway 136 in a geometric pattern. The geometric pattern may be different for various applications. For example, the plurality of apertures 130 may be arranged around the catalyst feed conduit passageway 136 in a grid and/or concentrically. The plate 102 can include 10 to 50 apertures 130 per square meter, such as between 20 to 35 apertures 130 per square meter. Other numbers of apertures 130 per square meter are also contemplated.

A ratio of an inside diameter of the first aperture portions 132 of the plate 102 to an inside diameter of the second aperture portions 134 of the plate 102 may be from 0.13 to 0.63, such as from 0.34 to 0.51. A ratio of the inside diameter of the first aperture portions 132 of the plate 102 to the inside diameter of the vessel 110 may be from 0.003 to 0.014, such as from 0.008 to 0.012. A ratio of the inside diameter of the second aperture portions 134 of the plate 102 to the inside diameter of the vessel 110 may be from 0.008 to 0.163, such as from 0.026 to 0.067.

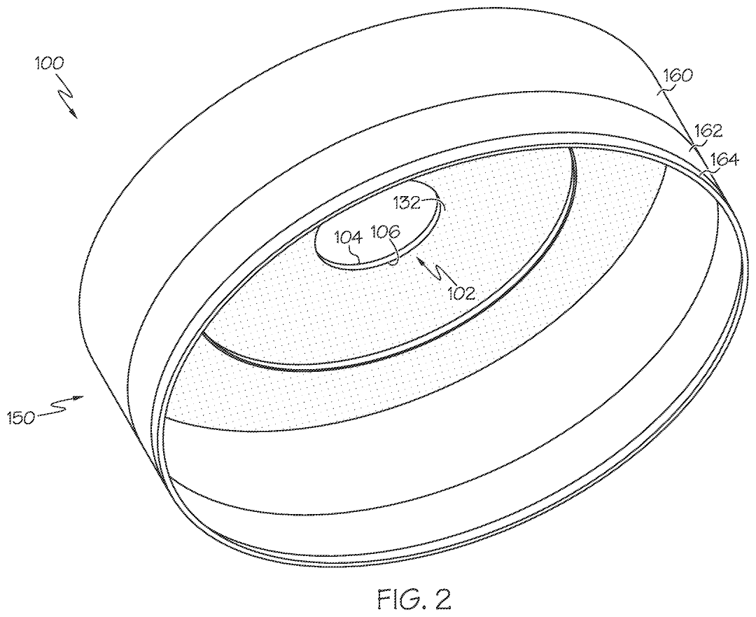

Referring to FIGS. 1 and 2, the plate grid distributor 100 may comprise a skirt 150. The skirt 150 may mount and support the plate 102 to the vessel 110 at or near the floor 116 of the vessel 110. The skirt 150 may extend downward at or near an outer periphery of the plate 102. As used in the present disclosure, “an outer periphery of the plate 102” may refer to the outermost (i.e., portion closest to the refractory-lined inner wall 112) 25% of the plate 102, or near that area. The skirt 150 may extend substantially vertically from the plate 102 towards the floor 116 of the vessel 110. As used in the present disclosure, “substantially vertically” may refer to an angle less than or equal to 45° (when at room temperature).

The skirt 150 may include a first end 152 and a second end 154. The first end 152 may connected to the floor 116 of the vessel 110. The second end 154 may be connected the plate 102. The first end 152 and the second end 154 may be spaced apart from one another. The space between the first end 152 and the second end 154 may define an outer surface 156 of the skirt 150. The outer surface 156 may be spaced apart from an inner surface 158 defining a width of the skirt 150. The outer surface 156 may be spaced apart from the refractory-lined inner wall 112. In embodiments, the skirt 150 may be angled (i.e., not vertical)

The skirt 150 may include a first portion 160 and a second portion 162. The first portion 160 may be in direct contact with the plate 102, such as at or near the second end 154 of the skirt 150. The second portion 162 may be positioned below the first portion 160 and may be in direct contact with the first portion 160. The second portion 162 may extend downward towards the floor 116 of the vessel 110, such as to the first end 152 of the skirt 150. The first portion 160 and the second portion 162 may be attached to one another. The first portion 160 and the second portion 162 may be welded, brazed, soldered, or attached to one another or attached using any other conventional or yet-to-be developed means.

The first portion 160 and the second portion 162 of the skirt 150 may be substantially ring-shaped members. The first portion 160 and the second portion 162 of the skirt 150 may follow the same shape as the refractory-lined inner wall 112, but may be hollow in the middle to allow other components of the vessel 110 or the plate grid distributor 100 to be disposed below the plate 102 and within the skirt 150.

The skirt 150 may include a third portion 164 positioned below the second portion 162. The third portion 164 may be in direct contact or integral with the second portion 162 and the floor 116 of the vessel 110. The third portion 164 may be welded, brazed, soldered, or attached to the second portion 162 or attached using any other conventional or yet-to-be developed means. The third portion 164 may be a substantially ring-shaped member. The third portion 164 of the skirt 150 may follow the same shape as the refractory-lined inner wall 112, but may be hollow in the middle to allow other components of the vessel 110 or the plate grid distributor 100 to be disposed below the plate 102 and within the skirt 150.

Generally, the temperature at or near the plate 102 may be much greater than that at the floor 116 and a large temperature differential is observed during reactor operation. With such temperature differentials, the first portion 160 may expand outwardly under high temperatures, while the third portion 164 does not expand a great deal due to lesser temperatures. This may cause bending in the skirt 150. Without being bound by theory, it is believed that the greatest stress placed on the skirt 150 when the first portion 156 expands is in the central region encompassing the second portion 160. Thus, it may be desirable to utilized a material with high allowable stress for the second portion as compared with the other portions of the skirt 150. However, such material may be very expensive, so this material is only utilized in the second portion 158 where stress is greatest.

The material of the first portion 160 may have a first allowable stress and the material of the second portion 162 may have a second allowable stress. As used in the present disclosure, “allowable stress” refers to the maximum stress that can be safely applied to a structure or material. As used herein, allowable stress of particular materials is documented by ASME Section 2, Part D, and the standards used to determine allowable stress in ASME Second 2, Part D may be applied to determine the allowable stress of a given material. As those skilled in the art will appreciate, allowable strength may be used interchangeably for allowable stress. Allowable stress is commonly measured at a specific temperature as the mechanical properties of a structure or material vary with changes in temperature. For example, the allowable stress of a material may not be as high at a greater temperature than the allowable stress of the same material at room temperature. It should be understood that as described herein materials that cannot survive any stress or are unstable at a particular temperature have an allowable stress of zero at that temperature.

In one or more embodiments, the second allowable stress may be greater than 3,000 psi at 1,400° F., such as greater than 3,050 psi, greater than 3,100 psi, greater than 3,150 psi, greater than 3,200 psi, greater than 3,250 psi, greater than 3,300 psi, greater than 3,350 psi, greater than 3,400 psi, greater than 3,450 psi, or greater than 3,500 psi at 1,400° F. 14,000° C. is chosen because it may be near the temperature of the atmosphere around the plate 102. However, the apparatuses described herein may be useful for reactors at different temperatures.

In one or more embodiments, the first allowable stress may be at least 200 psi less than the second allowable stress at 1,400° F., such as at least 250 psi less, at least 300 psi less, at least 350 psi less, at least 400 psi less, at least 450 psi less, or at least 500 psi less than the second allowable stress at 1,400° F.

The material of the third portion 164 may have a third allowable stress. The third allowable stress may be less than the first allowable stress. Additionally, the third allowable stress may be less than the second allowable stress. In embodiments, the third allowable stress may be at least 200 psi less than the first allowable stress at 1,400° F., such as at least 250 psi less, at least 300 psi less, at least 350 psi less, at least 400 psi less, at least 450 psi less, or at least 500 psi less than the second allowable stress at 1,400° F. The third allowable stress may be at least 200 psi less than the second allowable stress at 1,400° F., such as at least 250 psi less, 300 psi less, 350 psi less, 400 psi less, 450 psi less, or 500 psi less than the second allowable stress at 1,400° F.

The materials of the portions of the skirt 150 may each also have a respective coefficient of thermal expansion. The material of the second portion 162 may have a second coefficient of thermal expansion. The material of the third portion 164 may have a third coefficient of thermal expansion. In one or more embodiments, the coefficient of thermal expansion of the second portion 162 and third portion 164 are relatively similar, such as within 50%, 40%, 30%, 20%, or even 10% of one another. For example, the coefficient of thermal expansion of the second portion 162 may be about 9.4 in/° F. and the coefficient of thermal expansion of the third portion 164 may be about 8.1 in/° F. The similarity of theses coefficients of thermal expansion may be desirable because the strain at relatively high temperatures during processing conditions may be reduced at the junction of the second portion 162 and third portion 164.

In embodiments, the material of the first portion 160 may be SAE 304H stainless steel. The material of the second portion 162 may be INCOLOY® 800HT®. INCOLOY® 800HT® is a nickel-iron-chromium alloy having a minimum iron content of 39.5%, a nickel content ranging from 30-35%, a chromium content ranging from 19-23%, an aluminium content ranging from 0.25-0.60%, a titanium content ranging from 0.25-0.60%, an aluminium and titanium content ranging from 0.85-1.20%, and a carbon content ranging from 0.06-0.10%. The material of the third portion 164 may be the same material of a shell (i.e., the outer wall 114) of the vessel 110. In embodiments, the material of the third portion 164 may be carbon steel. Table I shows some properties of these materials.

TABLE I

| | | Approximate | Approximate | |
|---|---|---|---|---|
| | | Allowable | Allowable | Approximate |
| | | Stress at | Stress at | CTE at |
| Material | Portion | 1400° F. (psi) | 1000° F. (psi) | 1000° F. |
| SAE 304H | First | 2300 | 14000 | 1.03 |
| stainless steel | | | | |
| INCOLOY ® | Second | 3400 | 14000 | 9.4 |
| 800HT ® | | | | |
| Carbon Steel | Third | N/A (0) | 2500 | 8.1 |

The advantages of utilizing the materials discloses herein of the second portion 162 include a relative match of coefficient of thermal expansion with the third portion 164 as well as relatively high allowable stress at elevated tempters. However, these materials are only utilized in the portions of the system as described herein. Drawbacks of utilizing such materials include very high costs and increased problems in fabrication and machinability. Additionally, the nickel present in some embodiments may create coking, which is undesirable. Moreover, the addition of an additional metallic weld (as compared to comparative embodiments that do not include a second portion 162) is undesirable since it produces a point of relative weakness. However, it has been discovered presently in the embodiments described herein that the additional weakness introduced by an additional bi-metallic weld is overcome by the need for the high temperature stability properties of the material of the second portion 162 due to the expansion of the plate under high operating temperatures. This is particular important when utilizing large plate grids, such as those with a diameter over 20 ft.

Referring again to FIG. 1, the vessel 110 may include a gaseous feed conduit 123. The gaseous feed conduit 123 may be connected to a gaseous feed conduit receiving passageway 122 that extends through the floor 116 of the vessel 110. The vessel 110 may include a plurality of gaseous feed conduits 123. In embodiments, the plurality of gaseous feed conduits 123 may be connected to a plurality of gaseous feed conduit receiving passageways 122. The plurality of gaseous feed conduit receiving passageways 122 may encircle the longitudinal axis of the vessel 110.

The gaseous feed conduit 123 may be mounted flush with the refractory-lined inner wall 112 or can extend beyond the refractory-lined inner wall 112. A ratio of an inside diameter of the gaseous feed conduit 123 to an inside diameter of the vessel 110 may be from 0.06 to 0.77, such as from 0.20 to 0.23.

Still referring to FIG. 1, the vessel 110 may include a catalyst feed conduit 121. The catalyst feed conduit 121 may be connected to a catalyst feed conduit receiving passageway 120 that extends through the floor 116 of the vessel 110. In embodiments, the vessel 110 may include a plurality of catalyst feed conduits 121. The plurality of catalyst feed conduits 121 may be connected to a plurality of catalyst feed conduit receiving passageways 120. The plurality of catalyst feed conduit receiving passageways 120 may encircle the longitudinal axis of the vessel 110.

The catalyst feed conduit 121 may include a first end 121A and a second end 121B. The catalyst feed conduit 121A may extend through the refractory-lined inner wall 112 and the outer wall 114 of the vessel 110. The second end 121B may be positioned above the top surface 104 of the plate 102. The catalyst feed conduit 121 may extend through the catalyst feed conduit receiving passageway 120 and the catalyst feed conduit passageway 136 such that the second end 121B extends beyond the top surface 104 of the plate 102. A catalyst feed conduit cap 125 may be connected to the second end 121B by one or more connectors 127. The one or more connectors 127 may define gaps 129 through which catalyst can flow into the vessel 110. A ratio of an inside diameter of the catalyst feed conduit 121 to the inside diameter of the vessel 110 may be from 0.08 to 0.23, such as from 0.12 to 0.15.

Still referring to FIG. 1, the plate grid distributor 100 may include a catalyst feed conduit housing 180. The catalyst feed conduit 121 may be slidably housed in the catalyst feed conduit housing 180. The catalyst feed conduit 121 may be spaced apart from an inner surface 182 of the catalyst feed conduit housing 180. The catalyst feed conduit 121 may be slidably housed within the catalyst feed conduit housing 180 to allow for expansion of the catalyst feed conduit 121. For example, the catalyst feed passing through the catalyst feed conduit 121 may be heated, causing the catalyst feed conduit 121 to expand in length and diameter. As such, the catalyst feed conduit 121 can expand, as compared to a vessel 110 where the catalyst feed conduit 121 is welded in place, which may cause a potential for the welds to crack.

The catalyst feed conduit housing 180 may include a first end 180A proximate to the floor 116 of the vessel 110. The catalyst feed conduit housing 180 may include a second end 180B spaced apart from the floor 116 of the vessel 110 and proximate to the top surface 104 of the plate 102. The catalyst feed conduit housing 180 may include an outer surface 181 that is spaced apart from an inner surface 182 of the catalyst feed conduit housing 180. The outer surface 181 of the catalyst feed conduit housing 180 may be connected to an inner circumferential surface of the catalyst feed conduit passageway 136 and to the catalyst feed conduit receiving passageway 120. An inside diameter of the top surface 104 and/or bottom surface 106 may be welded to and/or supported by the catalyst feed conduit housing 180.

Catalyst feed conduit insulation packing may be disposed between the catalyst feed conduit 121 and the inner surface 182 of the catalyst feed conduit housing 180. The catalyst feed conduit insulation packing may help maintain a temperature of a catalyst feed. For example, a temperature of a gaseous feed entering through the gaseous feed conduit 123 may be different than a temperature of a catalyst feed entering through the catalyst feed conduit 121. For instance, where certain reactions are being performed in the vessel 110, a gaseous feed can enter through the gaseous feed conduit 123 at from 25 degrees Celsius (° C.) to 700° C. and a catalyst may enter the catalyst feed conduit 121 at 600° C. to 900° C. As such, if the gaseous feed contacts the catalyst feed conduit 121, which may be heated to 600° C. to 900° C. as a result of the catalyst flowing through it, the gaseous feed may begin to coke and cause the vessel 110 and/or plate grid distributor 100 to plug.

In embodiments, the catalyst feed conduit 121 may comprise a catalyst backflow diverter 184. The catalyst backflow diverter 184 may be connected to the catalyst feed conduit 121 proximate to the second end 121B of the catalyst feed conduit 121 above the top surface 104 of the plate 102. The catalyst backflow diverter 184 may extend from the catalyst feed conduit 121 and extends beyond the second end 180B of the catalyst feed conduit housing 180. The catalyst backflow diverter 184 may reduce catalyst introduction into the catalyst feed conduit insulation packing.

Referring again to FIG. 1, the present disclosure is also directed toward methods of distributing a fluid through a plate grid distributor 100 in a vessel 110. A method of distributing a fluid through a plate grid distributor 100 in a vessel 110 may include passing a fluid into the vessel 110 at reaction conditions through a gaseous feed conduit 123 below the plate grid distributor 100 and directing the fluid through a plate grid distributor 100 in the vessel 110. The plate grid distributor 100 may comprise a plate 102 and a skirt 150.

The plate grid distributor 100, the plate 102, and the skirt 150 may have any of the features previously discussed in this disclosure for the plate grid distributor 100, the plate 102, and the skirt 150, respectively.

During operation of the vessel 110, the floor 116 of the vessel 110 may be at a lower temperature than upper portions of the vessel 110, such as at the plate 102 of the plate grid distributor 100. In embodiments, the floor 116 of the vessel 110 may be at temperature ranging from greater than or equal to 350° F. to less than or equal to 600° F. during operation. The plate 102 of the plate grid distributor 100 may be at temperature ranging from greater than or equal to 1,400° C., such as from greater than or equal to 1,400° F. to less than or equal to 1,700° F., during operation. A temperature differential between the floor 116 of the vessel 110 and the plate 102 of the plate grid distributor 100 may be at least 100° F., such as at least 200° F., at least 300° F., or at least 400° F. during operation.

The plate 102 of the plate grid distributor 100 may have a coefficient of thermal expansion that is greater than the floor 116 of the vessel 110. Accordingly, due to the greater coefficient of thermal expansion and higher temperature during operation, an amount of expansion at the plate 102 may be greater than at the floor 116. The skirt 150 may bend to continue supporting the plate grid distributor 100 as the plate 102 expands outward during operation.

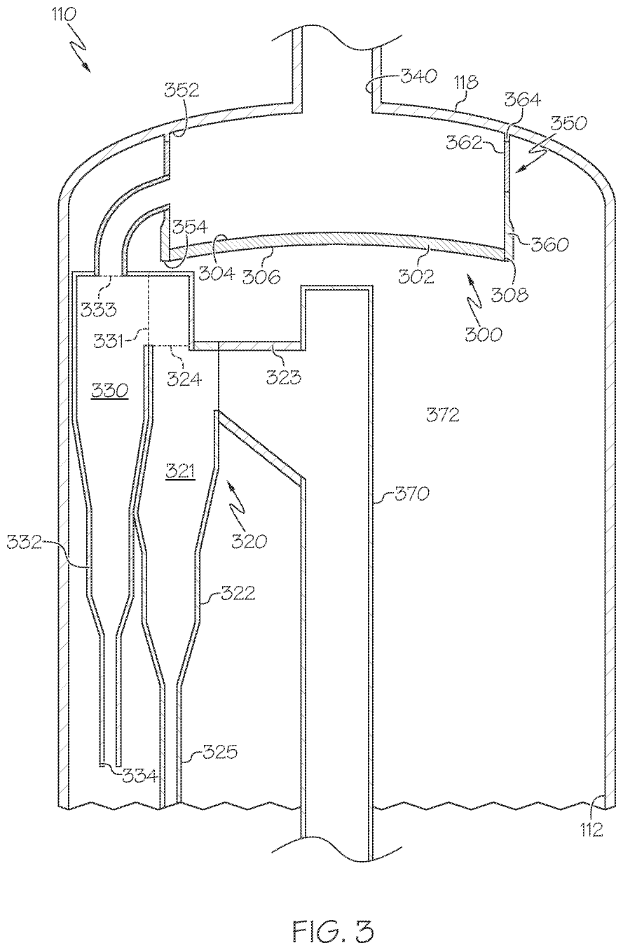

Referring now to FIG. 3, a plenum 300 for removing a fluid from the vessel 110 may include a plate 302 and a skirt 350. The plate 302 may include a top surface 304 and a bottom surface 306 opposite the top surface 304. The skirt 350 may be in direct contact with the top surface 304 of the plate 302 at or near an outer periphery of the plate 302. The skirt 350 may extend substantially vertically from the plate 302 and towards a top 118 of the vessel 110. The skirt 350 may include a first portion 360 and a second portion 362. The first portion 360 may be in direct contact with the plate 302. The material of the first portion 360 may have a first allowable stress. The second portion 362 may be positioned above the first portion 360 and may be in direct contact with the first portion 360. The second portion 362 may extend upward towards the top 118 of the vessel 110. The material of the second portion 362 may have a second allowable stress.

The plenums 300 of the present disclosure may be positioned in the vessel 110. The vessel 110 may have any of the features previously discussed in this disclosure for the vessel 110.

According to one or more embodiments, the plenum 300 for removing a fluid from the vessel 110 may comprise a plate 302. The plate 302 may comprise a top surface 304 and a bottom surface 306. The bottom surface 306 may be opposite the top surface 304 and may be spaced apart from the top surface 304. The plate 302 may comprise an outer surface 308. The outer surface 308 may have a portion that is normal to the top surface 304 and the bottom surface 306. The outer surface 308 can be welded to the top surface 304 and/or bottom surface 106. The plate 302 may have an average diameter from greater than or equal to 5 feet (1.5 meters (m)) to less than or equal to 75 feet (22.9 m), such as from greater than or equal to 10 feet (3.0 m) to less than or equal to 50 feet (15.2 m). The plate 302 may be substantially planar (i.e., the top surface 304 and the bottom surface 306 may be substantially parallel). However, it is contemplated that in additional embodiments, the plate 302 may be non-planar.

The plenum 300 may comprise a skirt 350. The skirt 350 may mount and support the plenum 300 to the vessel 110 at or near the top 118 of the vessel 110. The skirt 350 may extend upward at or near an outer periphery of the plenum 300. As used in the present disclosure, “an outer periphery of the plenum 302” may refer to the outermost (i.e., portion closest to the refractory-lined inner wall 112) 25% of the plenum 300, or near that area. The skirt 350 may extend substantially vertically from the plenum 300 towards the top 118 of the vessel 110. As used in the present disclosure, “substantially vertically” may refer to an angle less than or equal to 45°.

The skirt 350 may include a first end 352 and a second end 354. The first end 352 may connected to the top 118 of the vessel 110. The second end 354 may be connected the plenum 300. The first end 352 and the second end 354 may be spaced apart from one another. The space between the first end 352 and the second end 354 may define an outer planar surface 356. The outer planar surface 356 may be spaced apart from an inner planar surface 358. The outer planar surface 356 may be spaced apart from the refractory-lined inner wall 112. The outer planar surface 356 may be connected to a portion of the inner planar surface 358 proximate to the second end 354 and apart from the first end 352. In embodiments, the skirt 350 may be angled.

The skirt 350 may include a first portion 360 and a second portion 362. The first portion 360 may be in direct contact with the plenum 300, such as at the second end 354 of the skirt 350. The second portion 362 may be positioned above the first portion 360 and may be in direct contact with the first portion 360. The second portion 362 may extend upward towards the top 118 of the vessel 110, such as to the first end 352 of the skirt 350. The first portion 360 and the second portion 362 may be attached to one another. The first portion 360 and the second portion 362 may be welded, brazed, soldered, or attached to one another or attached using any other conventional or yet-to-be developed means.

The first portion 360 and the second portion 362 of the skirt 350 may be substantially ring-shaped members. The first portion 360 and the second portion 362 of the skirt 350 may follow the same shape as the refractory-lined inner wall 112, but may be hollow in the middle to allow other components of the vessel 110 or the plenum 300 to be disposed above the plate 302 and within the skirt 350.

The skirt 350 may include a third portion 364 positioned above the second portion 362. The third portion 364 may be in direct contact with the second portion 362 and the top 118 of the vessel 110. The third portion 364 may be welded, brazed, soldered, or attached to the second portion 362 or attached using any other conventional or yet-to-be developed means. The third portion 364 may be a substantially ring-shaped member. The third portion 364 of the skirt 350 may follow the same shape as the refractory-lined inner wall 112, but may be hollow in the middle to allow other components of the vessel 110 or the plenum 300 to be disposed above the plate 302 and within the skirt 350.

The materials and operation of the plenum of FIG. 3 may be analogous to the plate distributor of FIG. 1. For example, the thermal differential between the first end 352 and second end 354 of FIG. 3 may be analogous to that of the first end 152 and second end 154 in FIG. 1. Likewise, the materials of construction, the properties such as allowable stress, etc., of the first portion 360, second portion 362, and third portion 364 of the embodiment of FIG. 3 may be analogous to the first portion 160, second portion 162, and third portion 164 of the embodiment of FIG. 1. As such, all features disclosed with respect to the first portion 160, second portion 162, and third portion 164 should be understood as disclosed with respect to the first portion 360, second portion 362, and third portion 364.

The plenum 300 may be attached to a cyclonic separation device 320. The cyclonic separation device 320 may include at least one primary cyclone 321. The primary cyclone 321 may be contained within the vessel 110. The primary cyclone 321 may include a body 322, an inlet 323, an outlet 324, and a solids discharge dipleg 325. During operation, a fluidized solid stream may enter the primary cyclone 321 through the inlet 323. In the primary cyclone 321, a major part of entrained solids (e.g., catalyst particles) may be separated from the fluidized solid stream. The separated solids may exit the primary cyclone 321 through discharge dipleg 325. A primary cyclone effluent comprising solids not removed by the primary cyclone 321 and fluid (e.g., gaseous product) may continue vertically upwards through the primary cyclone 321. The primary cyclone effluent may pass vertically upward and out of the primary cyclone 321 through outlet 324 and into the one or more secondary cyclones 330 through secondary cyclone inlet(s) 331. The one or more secondary cyclones may include a body 332, an outlet 333, and a solids discharge dipleg 334. The secondary cyclone 330 may further separate out solids from the primary cyclone effluent. Solids separated out in the secondary cyclone 330 may exit downward through solids discharge dipleg 334. The secondary cyclone outlet 333 is fluidly connected to a plenum 300.

The vessel 110 may also house a riser 370. During operation, an unseparated stream of fluidized solid particles may enter the vessel 110 through the riser 370. The riser 370 may terminate in a plate 372. The riser 370 may fluidly connect (i.e., allow passage of the fluidized solid particles) with the inlet of the primary cyclone 321 such that the unseparated stream of fluidized solid particles may pass from the riser 370 into primary cyclone 321. If more than two cyclone stages are used, it is the effluent from the final cyclone stage which enters the second plenum. It will be understood that while FIG. 3 illustrates only one primary cyclone 321 and one secondary cyclone 330, additional primary and secondary cyclones may be placed around the periphery of the riser. For example, outlet tube 360 could be connected to another secondary cyclone (not shown) which in turn is fed either by primary cyclone 321 or by another primary cyclone (not shown). For further discussion on the cyclonic separation device, reference is made to U.S. Pat. No. 10,016,736 B2 (Attorney Ref. No. 75034-US-PCT/DOW 75034 PA).

During operation of the vessel 110, the top 118 of the vessel 110 may be at a lower temperature than lower portions of the vessel 110, such as at the plate 302 of the plenum 300. In embodiments, the top 118 of the vessel 110 may be at temperature ranging from greater than or equal to 350° F. to less than or equal to 600° F. during operation. The plate 302 of the plenum 300 may be at temperature ranging from greater than or equal to 1,400° C., such as from greater than or equal to 1,400° F. to less than or equal to 1,700° F., during operation. A temperature differential between the top of the vessel 110 and the plate 102 of the plenum 300 may be at least 100° F., such as at least 200° F., at least 300° F., or at least 400° F. during operation.

The plate 302 of the plenum 300 may have a coefficient of thermal expansion that is greater than the top 118 of the vessel 110. Accordingly, due to the greater coefficient of thermal expansion and higher temperature during operation, an amount of expansion at the plate 302 may be greater than at the top 118 of the vessel 110. As previously described in the present disclosure, the skirt 350 may bend to continue supporting the plenum 300 as the plate 302 expands outward during operation.

One or more aspects of the present disclosure are described herein. A first aspect may include a plate grid distributor for distributing a fluid in a vessel, the plate grid distributor comprising: a plate comprising a top surface, a bottom surface opposite the top surface, and a plurality of apertures passing from the top surface to the bottom surface; and a skirt in direct contact with the bottom surface of the plate at or near an outer periphery of the plate, the skirt extending substantially vertically from the plate and towards a floor of the vessel, wherein the skirt comprises: a first portion in direct contact with the plate, wherein the material of the first portion has a first allowable stress; and a second portion positioned below the first portion and in direct contact with the first portion and extending downward towards the floor of the vessel, wherein the material of the second portion has a second allowable stress; and wherein the second allowable stress is greater than 3,000 psi at 1,400° F.; and wherein the second allowable stress is at least 200 psi greater than that first allowable stress at 1,400° F.

A second aspect may include a plenum for removing a fluid from a vessel, the plenum comprising: a plate comprising a top surface and a bottom surface opposite the top surface; and a skirt in direct contact with the top surface of the plate at or near an outer periphery of the plate, the skirt extending substantially vertically from the plate and towards a top of the vessel, wherein the skirt comprises: a first portion in direct contact with the plate, wherein the material of the first portion has a first allowable stress; and a second portion positioned above the first portion and in direct contact with the first portion and extending upward towards the top of the vessel, wherein the material of the second portion has a second allowable stress; wherein the second allowable stress is greater than 3,000 psi at 1,400° F.; and wherein the second allowable stress is at least 200 psi greater than that first allowable stress at 1,400° F.

Another aspect includes any of the above aspects, wherein the second allowable stress is greater than 3,200 psi at 1,400° F.

Another aspect includes any of the above aspects, wherein the second allowable stress is from 3350 psi to 3450 psi at 1,400° F.

Another aspect includes any of the above aspects, wherein the material of the first portion is SAE 304H stainless steel.

Another aspect includes any of the above aspects, wherein the material of the second portion is INCOLOY® 800HT®.

Another aspect includes any of the above aspects, wherein the skirt further comprises a third portion positioned below the second portion and in direct contact with the second portion and the floor of the vessel, wherein the material of the third portion has a third allowable stress and the third allowable stress is less than the first allowable stress at 14,000° C.

Another aspect includes any of the above aspects, wherein the third portion comprises a material that is the same material as a shell of the vessel.

Another aspect includes any of the above aspects, wherein the material of the third portion is carbon steel.

A third aspect my include a method of distributing a fluid in a vessel, the method comprising: passing a fluid into the vessel at reaction conditions through a gaseous feed conduit below the plate grid distributor; directing the fluid through a plate grid distributor in the vessel, the plate grid distributor comprising: a plate comprising a top surface, a bottom surface opposite the top surface, and a plurality of apertures passing from the top surface to the bottom surface; and a skirt in direct contact with the bottom surface of the plate at or near an outer periphery of the plate, the skirt extending substantially vertically from the plate and towards a floor of the vessel, wherein the skirt comprises: a first portion in direct contact with the plate, wherein the material of the first portion has a first allowable stress; and a second portion positioned below the first portion and in direct contact with the first portion and extending downward towards the floor of the vessel, wherein the material of the second portion has a second allowable stress; wherein the first allowable stress is 200 psi less than the second allowable stress at 1,400° F.; and wherein the second allowable stress is greater than 3,000 psi at 1,400° F.; and wherein a temperature differential between the top surface of the plate and the floor of the vessel is greater than or equal to 500° F.

Another aspect includes any of the above aspects, wherein the temperature at the top surface of the plate is greater than or equal to 1,400° F.

Another aspect includes any of the above aspects, wherein the temperature at the floor of the vessel is from greater than or equal to 350° F. to less than or equal to 600° F.

Another aspect includes any of the above aspects, wherein the skirt further comprises a third portion in direct contact with the second portion and the floor of the vessel, wherein the material of the third portion has a third allowable stress and the third allowable stress is less than the first allowable stress at 1,400° F.

Another aspect includes any of the above aspects, wherein the material of the first portion is SAE 304 stainless steel and the material of the second portion is INCOLOY® 800HT®.

Another aspect includes any of the above aspects, wherein the material of the third portion is carbon steel.

Finally, it will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A plate grid distributor for distributing a fluid in a vessel, the plate grid distributor comprising:
a plate comprising a top surface, a bottom surface opposite the top surface, and a plurality of apertures passing from the top surface to the bottom surface; and
a skirt in direct contact with the bottom surface of the plate at or near an outer periphery of the plate, the skirt extending substantially vertically from the plate and towards a floor of the vessel, wherein the skirt comprises:
a first portion in direct contact with the plate, wherein the material of the first portion has a first allowable stress; and
a second portion positioned below the first portion and in direct contact with the first portion and extending downward towards the floor of the vessel, wherein the material of the second portion has a second allowable stress; and
wherein the second allowable stress is greater than 3,000 psi at 1,400° F.; and
wherein the second allowable stress is at least 200 psi greater than that first allowable stress at 1,400° F.

2. The plate grid distributor of claim 1, wherein the second allowable stress is greater than 3,200 psi at 1,400° F.

3. The plate grid distributor of claim 1, wherein the second allowable stress is from 3350 psi to 3450 psi at 1,400° F.

4. The plate grid distributor of claim 1, wherein the material of the first portion is SAE 304H stainless steel.

5. The plate grid distributor of claim 1, wherein the material of the second portion is INCOLOY® 800HT®.

6. The plate grid distributor of claim 1, wherein the skirt further comprises a third portion positioned below the second portion and in direct contact with the second portion and the floor of the vessel, wherein the material of the third portion has a third allowable stress and the third allowable stress is less than the first allowable stress at 1,400° F.

7. The plate grid distributor of claim 6, wherein:
the third portion comprises a material that is the same material as a shell of the vessel;
the material of the third portion is carbon steel;
or both.

8. A plenum for removing a fluid from a vessel, the plenum comprising:
a plate comprising a top surface and a bottom surface opposite the top surface; and
a skirt in direct contact with the top surface of the plate at or near an outer periphery of the plate, the skirt extending substantially vertically from the plate and towards a top of the vessel, wherein the skirt comprises:
a first portion in direct contact with the plate, wherein the material of the first portion has a first allowable stress; and
a second portion positioned above the first portion and in direct contact with the first portion and extending upward towards the top of the vessel, wherein the material of the second portion has a second allowable stress;
wherein the second allowable stress is greater than 3,000 psi at 1,400° F.; and
wherein the second allowable stress is at least 200 psi greater than that first allowable stress at 1,400° F.

9. The plenum of claim 8, wherein the second allowable stress is greater than 3,200 psi at 1,400° F.

10. A method of distributing a fluid in a vessel, the method comprising:
passing a fluid into the vessel at reaction conditions through a gaseous feed conduit below the plate grid distributor;
directing the fluid through a plate grid distributor in the vessel, the plate grid distributor comprising:
a plate comprising a top surface, a bottom surface opposite the top surface, and a plurality of apertures passing from the top surface to the bottom surface; and
a skirt in direct contact with the bottom surface of the plate at or near an outer periphery of the plate, the skirt extending substantially vertically from the plate and towards a floor of the vessel, wherein the skirt comprises:
a first portion in direct contact with the plate, wherein the material of the first portion has a first allowable stress; and
a second portion positioned below the first portion and in direct contact with the first portion and extending downward towards the floor of the vessel, wherein the material of the second portion has a second allowable stress;
wherein the first allowable stress is 200 psi less than the second allowable stress at 1,400° F.; and
wherein the second allowable stress is greater than 3,000 psi at 1,400° F.; and
wherein a temperature differential between the top surface of the plate and the floor of the vessel is greater than or equal to 500° F.

11. The method of claim 10, wherein the temperature at the top surface of the plate is greater than or equal to 1,400° F.

12. The method of claim 10, wherein the temperature at the floor of the vessel is from greater than or equal to 350° F. to less than or equal to 600° F.

13. The method of claim 10, wherein the skirt further comprises a third portion in direct contact with the second portion and the floor of the vessel, wherein the material of the third portion has a third allowable stress and the third allowable stress is less than the first allowable stress at 1,400° F.

14. The method of claim 10, wherein the material of the first portion is SAE 304 stainless steel and the material of the second portion is INCOLOY® 800HT®.

15. The method of claim 13, wherein the material of the third portion is carbon steel.
